(19) United States
(12) Patent Application Publication
(10) Pub. No.: US 2026/0276937 A1
(43) Pub. Date: Sep. 17, 2026

(54) FIBER OPTIC MODULE

(71) Applicant: STERLITE TECHNOLOGIES LIMITED, Gurugram (IN)

(72) Inventors: Shrinivas Hublikar, Gurugram (IN); Nandakumar Pawaskar, Gurugram (IN); Nitin Joshi, Gurugram (HR)

(21) Appl. No.: 19/168,874

(22) PCT Filed: Sep. 28, 2024
(86) PCT No.: PCT/IN2024/051886

§ 371 Date: Sep. 25, 2025

(30) Foreign Application Priority Data
Sep. 29, 2023 (IN) 202311065685

(51) Int. Cl. G02B 6/44

(52) U.S. Cl. CPC G02B 6/4453

(57) ABSTRACT

The present invention relates to a fiber optic module (102) having a base unit (104) defined by a base (200) and at least two opposing side walls (202) such that the base (200) and the at least two opposing side walls (202) forms a zone (204), a top plate (106) removably engaged with the base unit (104), and a single piece integrated adapter (108) removably engaged at the first end (104a) of the base unit (104). In particular, the base unit (104) has a first end (104a) and a second end (104b). Further, the top plate (106) and the base unit (104) define one or more openings (228a-228b) when the top plate (106) is attached to the base unit (104).

### CROSS-REFERENCE TO RELATED APPLICATIONS

The present application claims the benefit of PCT Application No. PCT/IN2024/051886 titled “FIBER OPTIC MODULE” filed by the applicant on Sep. 28, 2024, which claims the benefit of priority to Indian Application No. 202311065685, filed on Sep. 29, 2023, which is incorporated herein by reference in its entirety.

### FIELD OF THE INVENTION

Embodiments of the present invention relate to the field of wireless communication networks of optical fibres, and in particular, relates to a fiber optic module for management of a plurality of optical fibers.

### DESCRIPTION OF THE RELATED ART

Optical fiber refers to the technology and the medium for the transmission of data as light pulses along an ultrapure strand of glass, which is as thin as a human hair. For many years, optical fibers have been extensively used in high-performance and long-distance data and networking. Modern optical devices and optical communications systems widely use fiber optic cables. Fiber optic cables are often used to transmit light signals for high speed data transmission.

Optical fiber cables utilize optical fibers to transmit signals such as voice, video, image, data or information. Optical fibers are strands of glass fiber processed so that light beams transmitted through the glass fiber are subject to total internal reflection wherein a large fraction of the incident intensity of light directed into the fiber is received at the other end of the fiber.

Fiber optic cables are widely used to transmit light signals for high-speed data transmission. A fiber optic cable typically includes: (1) one or more optical fibers; (2) one or more buffers that surround the one more optical fibers; (3) at least one strengthening layer that surrounds the one mor more buffers; and (4) an outer jacket.

Benefits of optical fiber use include extremely wide bandwidth and low noise operation. Because of these advantages, optical fiber is increasingly being used for a variety of applications, including but not limited to broadband voice, video, and data transmission. Fiber optic networks employing optical fiber are being developed and used to deliver voice, video, and data transmissions to subscribers over both private and public networks.

The fiber optic equipment is customized based on the application needed. The fiber optic equipment is typically included in housings that are mounted in equipment racks to maximize space. One example of such fiber optic equipment is a fiber optic module.

A fiber optic module is designed to provide cable-to-cable fiber optic connections and manage the polarity of fiber optic cable connections. The fiber optic module is typically mounted to a chassis which is then mounted inside an equipment rack or housing. The chassis may be provided in the form of a tray that is extendable from the equipment rack like a drawer. This allows a technician access to fiber optic adapters disposed in the fiber optic module and any fiber optic cables connected to the fiber optic adapters without removing the fiber optic module from the equipment rack.

Due to increasing bandwidth needs and the need to provide high connectivity density in data centers for increased revenue generating opportunities, fiber optic 3 networks are migrating to higher cable fiber counts. Multi-fiber cables are used to provide higher cable fiber counts and are used for trunk connections in a fiber optic network. In general, higher density connections make it more difficult to access optical components and connections. The same is true for fiber optic modules because of the increased number of fiber optic adapters disposed in the fiber optic modules to handle the higher connectivity density. Increased density makes hand access to optical components and connectors as well as the routing and organizing jumper connections more difficult. Even with fiber optic equipment tray pull out capabilities, a need still exists to improve access to optical components in a fiber optic equipment tray as well as provide neat routing and organization of jumper connections.

Prior art reference “U.S. Pat. No. 8,712,206B2” discloses a fiber optic module having an internal chamber with plurality of simplex and/or duplex adapters at front side and a multi-fiber push-on (MPO) connector at a rear side. The MPO connector is further connected to each of the adapters in simplex and/or duplex adapters.

Another prior art reference “U.S. Pat. No. 10,295,761B2” discloses an optical fiber cassette module with a plurality of adapters at front side and an MPO at the rear side. Further, a 4 flexible substrate is present inside the module to align the fibers between the adapter and the MPO.

Yet another prior art reference “U.S. Pat. No. 10,094,996B2” discloses a fiber optic module having an internal chamber with a plurality of adapters at front side and an MPO at rear side. The MPO is connected to each of the adapters.

To fulfill the requirement of high-speed data transmission and increase in number of users, there is a requirement of high-density optical fiber systems such as high-density rack, chassis unit and along with high density cassette/modules. Traditionally available modules have multiple adapter units that consume a lot of space. Moreover, such modules have a single closed internal chamber which creates a weak design structure as the bottom panel of the module can be easily bent. Further, none of the prior art references provides a compact design for high density fiber management sub-rack/panel.

In light of the above stated discussion, there is a need for an efficient and effective optical fiber module that overcomes the above stated shortcomings of traditionally available modules. Thus, the present invention proposes a technical solution that overcomes the above-stated limitations in the prior arts by providing a fiber optic module for management of a plurality of optical fibers.

### SUMMARY OF THE INVENTION

Embodiments of the present invention relates to a fiber optic module comprising a base unit that is defined by a base and at least two opposing side walls such that the base and the at least two opposing side walls forms a zone, a top plate that is removably engaged with the base unit and a single piece integrated adapter that is removably engaged at the first end of the base unit. In particular, the base unit has a first end and a second end. Moreover, the top plate and the base unit define one or more openings when the top plate is attached to the base unit. Further, the base unit comprises one or more elongated walls partitioning the zone forming a plurality of sub-zones such that at least one sub-zone of the plurality of sub-zones has one or more base unit opening. In particular, the plurality of sub-zones comprising at least three sub-zones. Furthermore, a sub-zone of the plurality of sub-zone accommodates a slack of one or more optical waveguides when the one or more optical waveguides are bent at a radius of more than 12 millimetres (mm).

In accordance with an embodiment of the present invention, the second end of the base unit is adapted to be removably engaged with a multi-fiber push-on (MPO) connector, where the first end and the second end are opposite to each other.

In accordance with an embodiment of the present invention, a total width (TW) of the fiber optic module is in a range of 85 mm to 95 mm.

In accordance with an embodiment of the present invention, the single piece integrated adapter has at least 12 sub-adapters. In particular, the single piece integrated adapter is coupled to the MPO connector by way of a plurality of waveguides. Moreover, the single piece integrated adapter has a plurality of sub-adapters. Further, the plurality of sub-adapters are arranged on a plane such that each sub-adapter of the plurality of sub-adapters is adjacent to at least one or at most two sub-adapters.

In accordance with an embodiment of the present invention, width of each sub-adapter of the plurality of sub-adapters is 6 in a range of 7 mm to 8 mm such that a width of sub-adapters is in between 85 to 95 mm.

The foregoing objectives of the present invention are attained by a fiber optic module for management of a plurality of optical fibers.

### BRIEF DESCRIPTION OF THE DRAWINGS

So that the manner in which the above-recited features of the present invention is understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

The invention herein will be better understood from the following description with reference to the drawings, in which:

FIG. 1 illustrates a pictorial snapshot of an assembled version of a fiber optic module in accordance with an embodiment of the present invention;

FIG. 2A illustrates is a pictorial snapshot of a base unit of the fiber optic module in accordance with an embodiment of the present invention;

FIG. 2B illustrates a pictorial snapshot of the fiber optic module with a top plate attached to the base unit in accordance with an embodiment of the present invention;

FIG. 3 illustrates a pictorial snapshot of a single piece integrated adapter of the fiber optic module in accordance with an embodiment of the present invention;

FIG. 4A illustrates a pictorial snapshot of a partially assembled version of the fiber optic module in accordance with an embodiment of the present invention;

FIG. 4B illustrates a pictorial snapshot of the fiber optic module in accordance with an embodiment of the present invention;

FIG. 5A illustrates a pictorial snapshot of the top view of the fiber optic module in accordance with an embodiment of the present invention;

FIG. 5B illustrates a pictorial snapshot of the side view of the fiber optic module in accordance with an embodiment of the present invention;

FIG. 5C illustrates a pictorial snapshot of the front view of the fiber optic module in accordance with an embodiment of the present invention.

The fiber optic module is illustrated in the accompanying drawings, which like reference letters indicate corresponding parts in the various figures. It should be noted that the accompanying figure is intended to present illustrations of exemplary embodiments of the present invention. This figure is not intended to limit the scope of the present invention. It should also be noted that the accompanying figure is not necessarily drawn to scale.

### DETAILED DESCRIPTION OF THE INVENTION

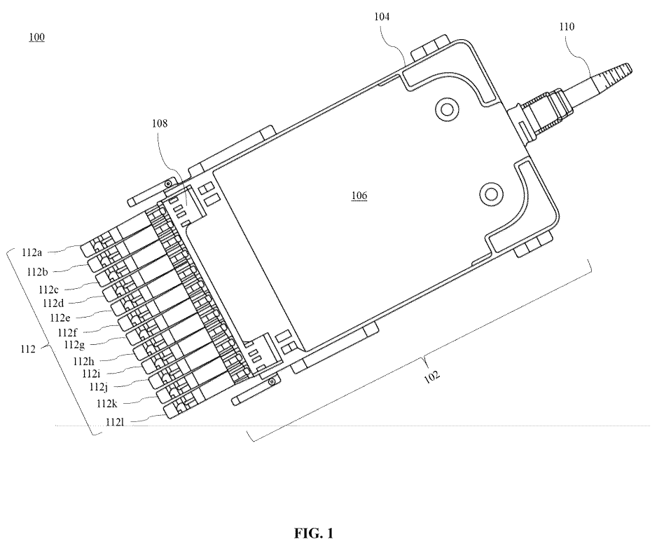

The principles of the present invention and their advantages are best understood by referring to FIG. 1 to FIG. 5C. In the following detailed description, numerous specific details are set forth in order to provide a thorough understanding of the embodiment of the invention as illustrative or exemplary embodiments of the invention, specific embodiments in which the invention may be practised are described in sufficient detail to enable those skilled in the art to practice the disclosed embodiments. However, it will be obvious to a person skilled in the art that the embodiments of the invention may be practised with or without these specific details. In other instances, well-known methods, procedures and components have not been described in detail so as not to unnecessarily obscure aspects of the embodiments of the invention.

The following detailed description is, therefore, not to be taken in a limiting sense, and the scope of the present invention is defined by the appended claims and equivalents thereof. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. References within the specification to “one embodiment,” “an embodiment,” “embodiments,” or “one or more embodiments” are intended to indicate that a particular feature, structure, or characteristic described in connection with the embodiment is included in at least one embodiment of the present invention.

Although the terms first, second, etc. may be used herein to describe various elements, these elements should not be limited by these terms. These terms are generally only used to distinguish one element from another and do not denote any order, ranking, quantity, or importance, but rather are used to distinguish one element from another. Further, the terms “a” and “an” herein do not denote a limitation of quantity, but rather denote the presence of at least one of the referenced items.

The conditional language used herein, such as, among others, “can,” “may,” “might,” “may,” “e.g.,” and the like, unless specifically stated otherwise, or otherwise understood within the context as used, is generally intended to convey that certain embodiments include, while other embodiments do not include, certain features, elements and/or steps.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

The term “optical fiber” as used herein refers to a light guide that provides high-speed data transmission. The optical fiber has one or more glass core regions and one or more glass cladding regions. The light moving through the glass core regions of the optical fiber relies upon the principle of total internal reflection, where the glass core regions have a higher refractive index (n1) than the refractive index (n2) of the glass cladding region of the optical fiber.

The term “optical fiber cable” as used herein refers to a cable that encloses one or more optical fibers.

The term “multi-fiber push on (MPO) connector” as used herein refers to a fiber connector having multiple optical fibers. The MPO connectors are typically available with 8, 12 or 24 fibers for common data centre and LAN applications.

The term “slacks of optical waveguides” as used herein refers to loops of extra optic fiber optic spun around specialized fixtures across a cable route.

The term “zone” as used herein refers to an internal storage space created inside a fiber optic module

The term “sub-zone” as used herein refers to one or more partitions created inside an internal storage space.

The term “adapter” as used herein refers to an optical component used to connect two or more optical fibers.

The term “waveguide” as used herein refers to one or more optical fibers connected between an MPO and single piece integrated adapter.

FIG. 1 illustrates a pictorial snapshot of an assembled version of a fiber optic module in accordance with an embodiment of the present invention. In particular, the fiber optic module 100 may be adapted to facilitate management of a plurality of optical fibers disposed inside the fiber optic module 102. Moreover, the fiber optic module 102 may be utilized in a fiber management system sub-rack unit.

In accordance with an embodiment of the present invention, the fiber optic module 102 may have a base unit 104, a top plate 106, and a single piece integrated adapter 108. Further, in operation, the fiber optic module 102 may be adapted to receive one or more attachments. The one or more attachments may include a multi-fiber push on (MPO) connector 110 and one or more patch cords 112 of which first through twelfth patch cords 112a-112l are shown.

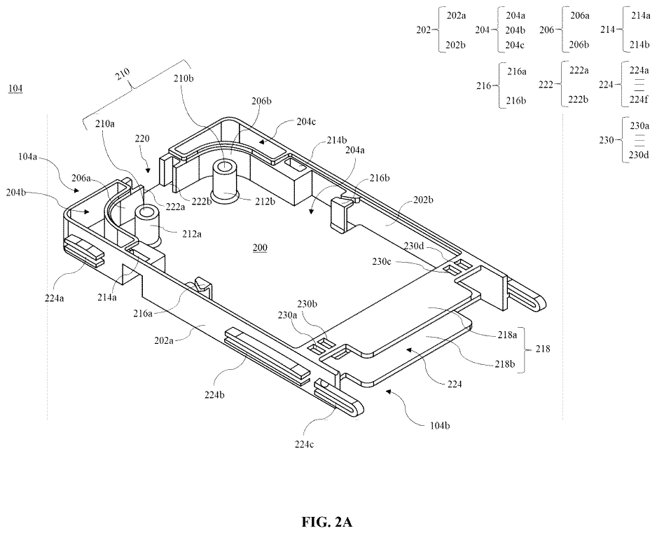

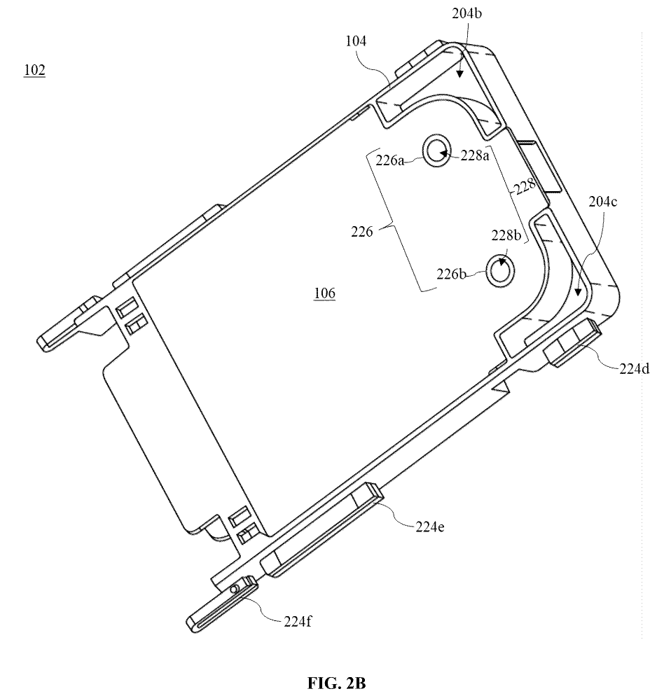

FIG. 2A illustrates a pictorial snapshot of a base unit of the fiber optic module in accordance with an embodiment of the present invention. In particular, the base unit 104 may be defined by a base 200 and at least two opposing side walls 202 of which first and second side walls 202a and 202b are shown. Moreover, the base 200 and the first and second side walls 202a and 202b form a zone 204. Further, zone 204 may be an internal 11 storage space created inside the fiber optic module 102.

In accordance with an embodiment of the present invention, the base unit 102 may have a first end 104a and a second end 104b that are opposite to each other. The base unit 104 may have one or more elongated walls 206 of which first and second elongated walls are shown 206a and 206b. In particular, the first and second elongated walls 206a and 206b may be adapted to partition the zone 204 to form a plurality of sub-zones 204a-204c. Further, the plurality of sub-zones 204a-204c may have at least three sub-zones 204a-204c to provide mechanical stability and design symmetry to the fiber optic module 102. At least one sub-zone of the at least three sub-zones 204a-204c may have one or more base unit openings 210.

In an exemplary example, the sub-zone 204a may have one or more base unit openings 210 of which first and second base unit openings 210a and 210b are shown.

In accordance with an embodiment of the present invention, the first and second base unit openings 210a and 210b may be formed by way of first and second cylindrical protrusions 212a and 212b, respectively. The first and second cylindrical protrusions 212a and 212b may extend in a vertically upward direction from the base 200. In particular, the first and second cylindrical protrusions 212a and 212b may be hollow structures thus forming the first and second base unit openings 210a and 210b, respectively.

In accordance with an embodiment of the present invention, a sub-zone of the plurality of sub-zones 204 may be adapted to accommodate a slack of one or more optical waveguides (not shown). In particular, when a sub-zone of the plurality of sub-zones 204 accommodates the slack of the one or more optical waveguides, the one or more optical waveguides may be bent at a radius of more than 12 millimeters (mm).

In an exemplary example, when the sub-zone 204b accommodates the slack of the one or more 12 optical waveguides, the one or more optical waveguides may be bent at the radius of more than 12 mm.

In an alternative embodiment,, when the one or more optical waveguides gets bend below the radius of 12 mm, light wave traveling through the one or more optical waveguides may face bending losses, thus, the sub-zone 204b are designed to accommodate the slack of the one or more optical waveguides in a way that the one or more optical waveguides are bent at the radius of more than 12 mm. Thus, formation of the plurality of sub-zones 204a-204c inside the fiber optic module 102 may facilitate in providing more strength to the inner space of the fiber optic module 102 by reducing flexibility of the base unit 104 of the fiber optic module 102 and hence, provides better alignment to the slack of waveguides inside the sub-zone 204a.

In accordance with an embodiment of the present invention, the base unit 104 may have a plurality of female ports 214 of which first and second female ports 214a and 214b are shown, a plurality of fiber supports 216 of which first and second supports 216a and 216b are shown, a plurality of adapter holders 218 of which first and second adapter holders 218a and 218b are shown, a channel 220, a plurality of MPO holders 222 of which first and second MPO holders 222a and 222b are shown, and a plurality of guide slots 224.

In accordance with an embodiment of the present invention, the first and second female ports 214a and 214b may be disposed near bottom ends of the second and third sub-zones 204b and 204c, respectively. In particular, the first and second female ports 214a and 214b may be adapted to receive first and second male ports (not shown) of the top plate 106 (as shown in FIG. 2B) when the top plate 106 is attached to the base unit 104. Although FIG. 2A illustrates that the plurality of female ports 214 has two female ports (i.e., the first and second female ports 214a and 214b), it will be apparent to a person skilled in the art that the scope of the present invention is 13 not limited to it. In various other aspects, the plurality of female ports 214 may have more than two female ports without deviating from the scope of the present invention. In such a scenario, each female port is adapted to perform one or more operations in a manner similar to the operations of the first and second female ports 214a and 214b as described herein.

In accordance with an embodiment of the present invention, the first and second fiber supports 216a and 216b may be disposed along the first and second elongated walls are shown 206a and 206b, respectively. In particular, the first and second fiber supports 216a and 216b may be adapted to provide a rigid support to the optical fibers disposed inside the fiber optic module 102. Although FIG. 2A illustrates that the plurality of fiber supports 216 has two fiber supports (i.e., the first and second fiber supports 216a and 216b), it will be apparent to a person skilled in the art that the scope of the present invention is not limited to it. In various other aspects, the plurality of fiber supports 216 may have more than two fiber supports without deviating from the scope of the present invention. In such a scenario, each fiber support is adapted to perform one or more operations in a manner similar to the operations of the first and second fiber supports 216a and 216b as described herein.

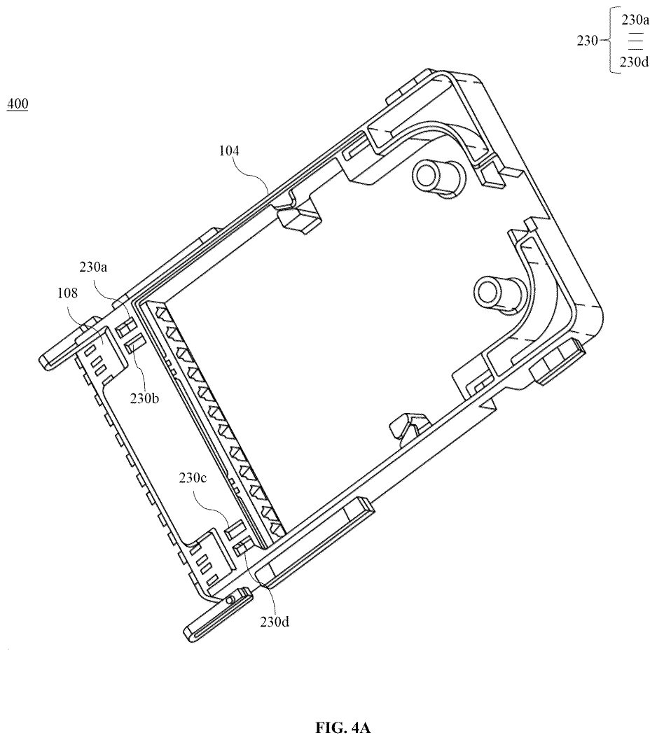

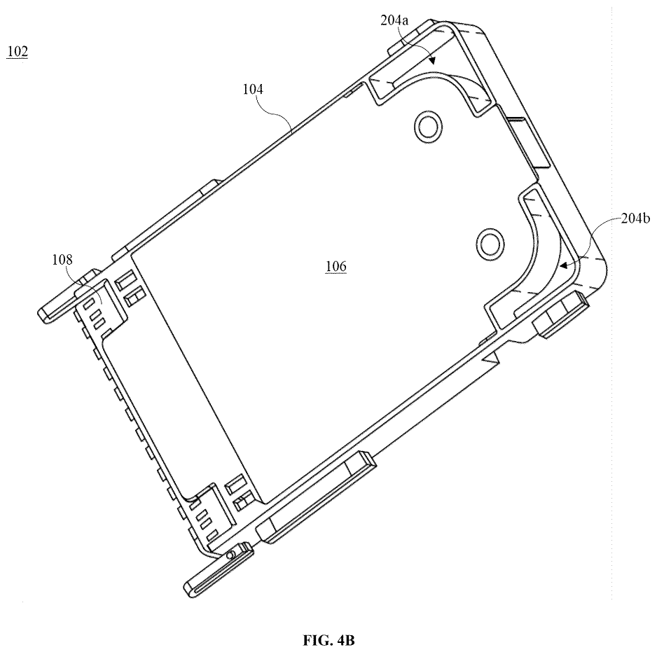

In accordance with an embodiment of the present invention, the first and second adapter holders 218a and 218b may be parallel plates extending from the second end 104b of the base unit 104 to define a slot 224. In particular, the slot 224 may be adapted to accept the single piece integrated adapter 108 (as shown in FIG. 4A). Further, the single piece integrated adapter 108 is a single molded optical component that may be used to connect at least 12 optical fibers to another 12 optical fibers. Hence, the single piece integrated adapter 108 may facilitate in elimination of 14 the usage of plurality of interconnected simplex, duplex, and/or quad adapters to achieve a high-density fiber adapter in the fiber optic module 102.

In accordance with an embodiment of the present invention, the first and second adapter holders 218a and 218b may have a plurality of through holes 230 of which first through fourth through holes 230a-230d are shown such that the first through fourth through holes 230a-230d enable a snap fit locking mechanism to lock the single piece integrated adapter 108 within the base unit 104.

In accordance with an embodiment of the present invention, the channel 220 may be provided on the first end 104a of the base unit 104. In particular, the first and second MPO holders 222a and 222b may define the channel 220. Moreover, the first and second MPO holders 222a and 222b may have first and second slots, respectively, such that the first and second slots of the first and second MPO holders 222a and 222b, respectively, are adapted to receive the MPO connector 110. Further, the plurality of guide slots 224 may have first through sixth guide slots 224a-224f disposed on an outer surface of the first and second side walls 202a and 202b. Furthermore, the first through third guide slots 224a-224c may be disposed on the outer surface of the first side wall 202a and the fourth through sixth guide slots 224d-224f (as shown in FIG. 2B) may be disposed on the outer surface of the second side wall 202b. And, the first through sixth guide slots 224a-224f may be adapted to facilitate attachment of the fiber optic module 102 with a fiber module mounting system (not shown).

FIG. 2B illustrates a pictorial snapshot of the fiber optic module with a top plate attached to the base unit in accordance with an embodiment of the present invention. As illustrated, the top plate 106 may be removably engaged with the base unit 104. 15 Particularly, the top plate 106 may have a plurality of male connectors (not shown) that may be inserted into the plurality of female ports 214 (as shown in FIG. 2A) when the top plate 106 is attached to the base unit 104. Moreover, the top plate 106 may have a shape that may be similar to a shape of the base unit 104 such that the second and third sub-zones 204b-204c are open from a top portion. Further, the top plate 106 may have one or more top openings 226 of which first and second top openings 226a and 226b are shown.

In accordance with an embodiment of the present invention, the first and second top openings 226a and 226b may be aligned with the first and second base unit openings 210a and 210b (as shown in FIG. 2A) when the top plate 106 is attached to the base unit 104 to define one or more openings 228 of which first and second openings 228a-228b are shown. Further, the first and second top openings 226a and 226b may be aligned with the first and second base unit openings 210a and 210b (as shown in FIG. 2A) when the top plate 106 is attached to the base unit 104 to define one or more openings (i.e., the first and second openings 228a-228b).

In accordance with an embodiment of the present invention, the top plate 106 may have a perforated and/or a grid like structure to make the inner space of the fiber optic module 102 open. In particular, the one or more openings 228 (i.e., the first and second openings 228a-228b) may have a shape selected from, but not limited to, an oval shape, a square shape, and the like. Moreover, the shape of the one or more openings 228 (i.e., the first and second openings 228a-228b) may be circular. Further, the circular shape of the one or more openings 228 (i.e., the first and second openings 228a-228b) may facilitate mechanical stability and design strength to the fiber optic module 102.

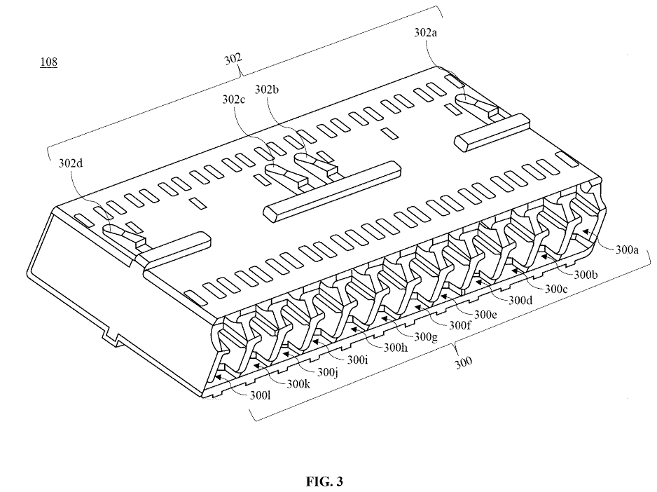

FIG. 3 illustrates a pictorial snapshot of a single piece integrated adapter of the fiber optic module in accordance with an embodiment of the present invention. In particular, the single piece integrated adapter 108 may be adapted to be removably engaged at the first end 104a (as shown in FIG. 2A) of the base unit 104 by way of the first and second adapter holders 218a and 218b (as shown in FIG. 2A). Moreover, the single piece integrated adapter 108 may be snap fitted by way of the first through fourth through holes 230a-230d (as shown in FIG. 2A) of the first and second adapter holders 218a and 218b (as shown in FIG. 2A), respectively. Further, the single piece integrated adapter 108 may have a plurality of sub-adapters 300.

In accordance with an embodiment of the present invention, the plurality of sub-adapters 300 may have at least 12 sub-adapters i.e., first through twelfth sub-adapters 300a-300l. The first through twelfth sub-adapters 300a-300l may be arranged on a plane such that each sub-adapter of the plurality of sub-adapters 300 (i.e., the first through twelfth sub-adapters 300a-300l) is adjacent to at least one and/or at most two sub-adapters of the plurality of sub-adapters 300.

In accordance with an embodiment of the present invention, the plurality of sub-adapters 300 (i.e., the first through twelfth sub-adapters 300a-300l) may be arranged adjacent to one another in a plane such that each sub-adapter has at least one and/or at most two adjacent sub-adapters.

In accordance with an embodiment of the present invention, a width of each sub-adapter of the plurality of sub-adapters 300 may be in a range of 7 mm to 8 mm.

In accordance with an embodiment of the present invention, the plurality of sub-adapters 300 may have at least one of, LC adapter and SC adapter. In particular, the single piece integrated adapter 108 may integrate the plurality of sub-adapters 300 (that can be a plurality of LC adapters and/or a plurality of SC adapters), without any additional interconnecting component and hence, the plurality of sub-adapters 300 are non-separable from each other. Alternatively, the single piece integrated adapter 108 may be fabricated by way of a single molding process.

In accordance with an embodiment of the present invention, the single piece integrated adapter 108 may be coupled to the MPO connector 110 (as shown in FIG. 1) by way of a plurality of waveguides (not shown).

In accordance with an embodiment of the present invention, the single piece integrated adapter 108 may have a plurality of tabs 302 of which first through fourth tabs 302a-302d are shown. In particular, the first through fourth tabs 302a-302d may be adapted to facilitate attachment of the single piece integrated adapter 108 with the base unit 104. Further, the first through fourth tabs 302a-302d may be inserted into the first through fourth through holes 230a-230d (as shown in FIG. 2A) such that the first through fourth through holes 230a-230d and the first through fourth tabs 302a-302d enables the snap fit locking mechanism to lock the single piece integrated adapter 108 within the base unit 104.

In some aspects of the present invention, the single piece integrated adapter 108 having the plurality of sub-adapters 300 may be fabricated by way of a single molding process.

FIG. 4A illustrates a pictorial snapshot of a partially assembled version of the fiber optic module in accordance with an embodiment of the present invention. Particularly, the base unit 104 may be adapted to accept the single piece integrated 18 adapter 108 to form the partially assembled version 400 of the fiber optic module 102. Moreover, the first through fourth tabs 302a-302d (as shown in FIG. 3) of the single piece integrated adapter 108 may be inserted into the first through fourth through holes 230a-230d of the base unit 104 such that the first through fourth through holes 230a-230d (as shown in FIG. 2A). Further, the first through fourth tabs 302a-302d enables the snap fit locking mechanism to lock the single piece integrated adapter 108 within the base unit 104.

FIG. 4B illustrates a pictorial snapshot of the fiber optic module in accordance with an embodiment of the present invention. In particular, the fiber optic module 102 has the base unit 104, the top plate 106, and the single piece integrated adapter 108. Moreover, the base unit 104 may be adapted to accept the single piece integrated adapter 108. Further, the first through fourth tabs 302a-302d of the single piece integrated adapter 108 may be inserted into the first through fourth through holes 230a-230d (as shown in FIG. 4A) of the base unit 104 such that the first through fourth through holes 230a-230d and the first through fourth tabs 302a-302d (as shown in FIG. 3) enables the snap fit locking mechanism to lock the single piece integrated adapter 108 within the base unit 104. Furthermore, the top plate 108 may be attached to the base unit 104 such that the second and third sub-zones 204b and 204c are open from the top portion.

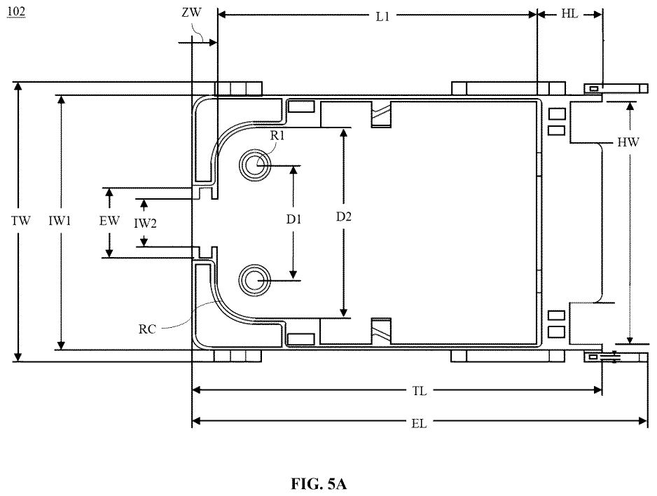

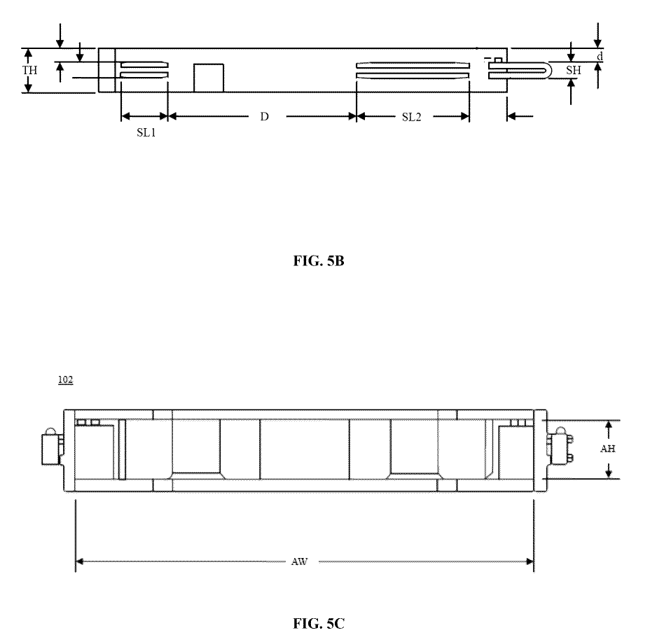

FIG. 5A illustrates a pictorial snapshot illustrating a top view of the fiber optic module in accordance with an embodiment of the present invention The fiber optic module 102 may have a total width (TW) (i.e., including a width (W) of the plurality of guide slots 224) in a range of 85 millimeters (mm) to 95 mm. In particular, the total width (TW) of the fiber optic module 102 may be 88.8 mm. Specifically, the total width (TW) in the range 19 of 85 mm to 95 mm is a standard dimensional value decided by international bodies so that a 12 fiber optical fiber can be fitted into a standard sub-unit and the sub-unit can be fitted into a standard rack unit. In this way, the fiber optic module 102, a sub-unit and a rack unit are compatible with each other regardless of manufacturer.

In accordance with an embodiment of the present invention, the fiber optic module 102 may have an internal width (IW1) (i.e., excluding the width (W) of the plurality of guide slots 224) in a range of 75 millimeters (mm) to 85 mm. Preferably, the internal width (IW1) may be 80.5 mm.

In accordance with an embodiment of the present invention, the width (W) of the plurality of guide slots 224 may be 1.4 mm.

In accordance with an embodiment of the present invention, the channel 220 may have an external width (EW) (i.e., including a width of the plurality of MPO holders 222) in a range of 20 mm to 25 mm. Preferably, the external width (EW) of the channel 220 may be 22.4 mm.

In accordance with an embodiment of the present invention, the channel 220 may have an internal width (IW2) (i.e., excluding the width of the plurality of MPO holders 222) in a range of 12 mm to 17 mm. Preferably, the internal width (IW2) of the channel 220 may be 15 mm.

In accordance with an embodiment of the present invention, the first and second cylindrical protrusions 212a and 212b may have a distance (D1) in a range of 32 mm to 39 mm. Preferably, the distance (D1) may be 36.5 mm.

In accordance with an embodiment of the present invention, each of the first and second cylindrical protrusions 212a and 212b may have a radius (R1) of 7.9 mm. In particular, the one or more openings 228 (i.e., the first and second openings 228a-228b) may have the radius (R1) of 7.9 mm.

In some aspects of the present invention, the first and second elongated walls 206a and 206b may have a distance (D2) in a range of 55 mm to 65 mm. Preferably, the distance (D2) may be 60.5 mm.

In accordance with an embodiment of the present invention, the first and second elongated walls 206a and 206b may have a radius of curvature (RC) of 12 mm.

In accordance with an embodiment of the present invention, the second and third sub-zones 204b and 204c may have a zone width (ZW) (when determined from the first end 104a of the base unit 104) in a range of 7.5 mm to 8.5 mm. Preferably, the zone width (ZW) may be 7.8 mm.

In accordance with an embodiment of the present invention, the base unit 104 may have a first length (L1) (i.e., excluding a length of the plurality of adapter holders 218 and a length of the plurality of MPO holders 222) in a range of 95 mm to 105 mm. Preferably, the first length (L1) may be 101.8 mm.

In accordance with an embodiment of the present invention, each adapter holder of the plurality of adapter holders 218 may have a holder width (HW) in a range of 70 mm to 80 mm. Preferably, the holder width (HW) may be 76.5 mm.

In accordance with an embodiment of the present invention, each adapter holder of the plurality of adapter holders 218 may have a holder length (HL) in a range of 15 mm to 25 mm. Preferably, the holder length (HL) may be 20.4 mm.

In accordance with an embodiment of the present invention, the fiber optic module 102 may have a total length (TL) (i.e., including the holder length (HL)) in a 21 range of 125 mm to 135 mm. Preferably, the total length (TL) of the fiber optic module 102 may be 130 mm.

In some aspects of the present invention, the fiber optic module 102 may have an external length (EL) (i.e., including a partial length of the third and sixth guide slots 224c and 224f) in a range of 140 mm to 150 mm. Preferably, the external length (EL) of the fiber optic module 102 may be 144.2 mm.

FIG. 5B illustrates a pictorial snapshot of a side view of the fiber optic module in accordance with an embodiment of the present invention. The fiber optic module 102 may have a total height (TH) in a range of 13 mm to 14 mm. In particular, the total height (TH) may be 13.5 mm. Moreover, the plurality of guide slots 224 may have a slot height (SH) in a range of 4 mm to 6 mm. Further, the slot height (SH) may be 5 mm. In some aspects of the present invention, the first and fourth guide slots 224a and 224d may have a first slot length (SL1) in a range of 12 mm to 17 mm. Furthermore, the first slot length (SL1) may be 15 mm. Similarly, the second and fifth guide slots 224b and 224e may have a second slot length (SL2) in a range of 32 mm to 38 mm. Preferably, the second slot length (SL2) may be 36 mm.

In accordance with an embodiment of the present invention, a distance (D) between the first and second guide slots 224a and 224b and the fourth and fifth guide slots 224d and 224e may be in a range of 58 mm to 62 mm. Preferably, the distance (D) may be 60 mm.

In accordance with an embodiment of the present invention, the plurality of guide slots 224 may be disposed at a distance (d) of 4.3 mm from a top edge of the fiber optic module 102.

FIG. 5C illustrates a pictorial snapshot of a front view of the fiber optic module in accordance with an embodiment of the present invention. The single piece integrated adapter 108 may have an adapter width (AW) in a range of 85 mm to 95 mm. In particular, a width of each sub-adapter of the plurality of sub-adapters 300 may be in a range of 7 mm to 8 mm such that the adapter width (AW) is in the range of 85 mm to 95 mm which is substantially similar to the total width (TW) of the of the fiber optic module 102. Preferably, the adapter width (AW) may be 88.8 mm.

In accordance with an embodiment of the present invention, the single piece integrated adapter 108 may have an adapter height (AH) in a range of 9.5 mm to 10.5 mm. Preferably, the adapter height (AH) may be 9.9 mm.

The fiber optic module 102 featuring a single-piece integrated adapter 108 with at least 12 sub-adapters 300 offers significant advantages for high-density applications, particularly in data centers. Unlike traditional modules that include one or more extra spacings, walls, or divisions between adjacent sub-adapters, this design eliminates those gaps, allowing a more compact and efficient arrangement. By maintaining a total module width between 85 mm and 95 mm, while ensuring each sub-adapter measures only 7 mm to 8 mm wide, the module achieves a higher port density within a smaller footprint. This is especially valuable in data centers, where maximizing connectivity while minimizing space is critical for efficient rack utilization and airflow management. Having a minimum of 12 sub-adapters is especially beneficial because it strikes an optimal balance between maximizing connectivity and maintaining manageable complexity in installation and maintenance. This higher port count per module reduces the number of individual modules needed, saving valuable rack space and simplifying cable management. Moreover, the design is particularly well-suited for connecting high-density cables incorporating ribbons, such as IBRs, where each ribbon contains 12 or more optical fibers. The unified adapter structure also simplifies installation and alignment, reducing assembly time and improving reliability key factors in data center operations where downtime and maintenance costs must be minimized. Overall, this design optimizes space utilization and scalability, making it highly efficient for supporting the demanding, high-capacity fiber optic connectivity needs of modern data centers.

Advantageously, the fiber optic module 102, by way of the single piece integrated adapter 108, eliminates the requirement of interconnection between plurality of small sized adapters and hence, the fiber optic module 102 has a compact design with improved strength. Particularly, the plurality of sub-adapters 300 of the single piece integrated adapter 108, are not separable from each other. Also, formation of the plurality of sub-zones 204a-204c inside the fiber optic module 102, facilitates in providing more strength to the inner space of the fiber optic module 102 by reducing flexibility of the base unit 104 of the fiber optic module 102 and hence, provides better alignment to the slack of waveguides inside the sub-zone 204a. Further, the first and second cylindrical protrusions 212a and 212b provide additional strength to the base unit 104 of the fiber optic module 102.

In a case that no conflict occurs, the embodiments in the present invention and the features in the embodiments may be mutually combined. The foregoing 23 descriptions are merely specific implementations of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

What is claimed for:

1. A fiber optic module (102)comprising:
a base unit (104) that is defined by a base (200) and at least two opposing side walls (202) such that the base (200) and the at least two opposing side walls (202) forms a zone (204), wherein the base unit (104) has a first end (104a) and a second end (104b);
a top plate (106) that is removably engaged with the base unit (104), wherein the top plate (106) and the base unit (104) defines one or more openings (228a-228b) when the top plate (106) is attached to the base unit (104); and
a single piece integrated adapter (108) that is removably engaged at the first end (104a) of the base unit (104).

2. The fiber optic module (102) of claim 1, where the single piece integrated adapter (108) has at least 12 sub-adapters.

3. The fiber optic module (102) of claim 1, wherein the base unit (104) further comprising one or more elongated walls (206) partitioning the zone (204) forming a plurality of sub-zones (204a-204c) such that at least one sub-zone of the plurality of sub-zones (204a-204c) has one or more base unit openings (210).

4. The fiber optic module (102) of claim 3, wherein the plurality of sub-zones (204) comprising at least three sub-zones (204a-204c).

5. The fiber optic module (102) of claim 3, wherein a sub-zone of the plurality of sub-zones (204) accommodates a slack of one or more optical waveguides.

6. The fiber optic module (102) of claim 5, where, when a sub-zone of the plurality of sub-zones (204) accommodates the slack of the one or more optical waveguides, the one or more optical waveguides are bent at a radius of more than 12 millimetres (mm).

7. The fiber optic module (102) of claim 1, wherein the second end (104b) of the base unit (104) is adapted to be removably engaged with a multi-fiber push on (MPO) connector (110), where the first end (104a) and the second end (104b) are opposite to each other.

8. The fiber optic module (102) of claim 1, where a total width (TW) of the fiber optic module (102) is in a range of 85 mm to 95 mm.

9. The fiber optic module (102) of claim 1, wherein the single piece integrated adapter (108) is coupled to the MPO connector (110) by way of a plurality of waveguides.

10. The fiber optic module (102) of claim 1, where the single piece integrated adapter (102) has a plurality of sub-adapters (300), where the plurality of sub-adapters (300) are arranged on a plane such that each sub-adapter of the plurality of sub-adapters (300) is adjacent to at least one or at most two sub-adapters.

11. The fiber optic module (102) of claim 1, wherein a width of each sub-adapter of the plurality of sub-adapters (300) is in a range of 7 mm to 8 mm such that a width of sub-adapters is in between 85 to 95 mm.

12. A fiber optic module (102) comprising:
a base unit (104) that is defined by a base (200) and at least two opposing side walls (202) such that the base (200) and the at least two opposing side walls (202) forms a zone (204), wherein the base unit (104) has a first end (104a) and
a second end (104b);
a top plate (106) that is removably engaged with the base unit (104),
wherein the top plate (106) and the base unit (104) defines one or more openings (228a-228b) when the top plate (106) is attached to the base unit (104); and one or more elongated walls (206) partitioning the zone (204) forming a plurality of sub-zones (204a-204c) such that at least one sub-zone of the plurality of sub-zones (204a-204c) has one or more base unit openings (210), wherein the plurality of sub-zones (204) comprising at least three sub-zones (204a-204c),
wherein, when a sub-zone of the plurality of sub-zones (204) accommodates the slack of the one or more optical waveguides, the one or more optical waveguides are bent at a radius of more than 12 millimetres (mm).

13. The fiber optic module (102) of claim 12 further comprising a single piece integrated adapter (108) that is removably engaged at the first end (104a) of the base unit (104), where the single piece integrated adapter (108) has at least 12 sub-adapters.

14. The fiber optic module (102) of claim 12, wherein a total width (TW) of the fiber optic module (102) is in a range of 85 mm to 95 mm.

15. The fiber optic module (102) of claim 12, wherein the single piece integrated adapter (108) is coupled to the MPO connector (110) by way of a plurality of waveguides.

16. The fiber optic module (102) of claim 12, wherein the single piece integrated adapter (102) has a plurality of sub-adapters (300), where the plurality of sub-adapters (300) are arranged on a plane such that each sub-adapter of the plurality of sub-adapters (300) is adjacent to at least one or at most two sub-adapters.

17. The fiber optic module (102) of claim 16, wherein a width of each sub-adapter of the plurality of sub-adapters (300) is in a range of 7 mm to 8 mm such that a width of sub-adapters is in between 85 to 95 mm.

18. A fiber optic module (102) comprising:
a base unit (104) that is defined by a base (200) and at least two opposing side walls (202) such that the base (200) and the at least two opposing side walls (202) forms a zone (204), where the base unit (104) has a first end (104a) and a second end (104b);
a top plate (106) that is removably engaged with the base unit (104), wherein the top plate (106) and the base unit (104) defines one or more openings (228a-228b) when the top plate (106) is attached to the base unit (104); and a single piece integrated adapter (108) that is removably engaged at the first end (104a) of the base unit (104)
wherein the single piece integrated adapter (102) has a plurality of sub-adapters (300);
wherein the plurality of sub-adapters (300) are arranged on a plane such that each sub-adapter of the plurality of sub-adapters (300) is adjacent to at least one or at most two sub-adapters.

19. The fiber optic module (102) of claim 18, wherein a width of each sub-adapter of the plurality of sub-adapters (300) is in a range of 7 mm to 8 mm such that a width of sub-adapters is in between 85 to 95 mm.

20. The fiber optic module (102) of claim 12 further comprising one or more elongated walls (206) partitioning the zone (204) forming a plurality of sub-zones (204a-204c) such that at least one sub-zone of the plurality of sub-zones (204a-204c) has one or more base unit openings (210), where the plurality of sub-zones (204) comprising at least three sub-zones (204a-204c), where, when a sub-zone of the plurality of sub-zones (204) accommodates the slack of the one or more optical waveguides, the one or more optical waveguides are bent at a radius of more than 12 millimetres (mm).
